(19) United States
(12) Patent Application Publication
(10) Pub. No.: US 2026/0309308 A1
(43) Pub. Date: Oct. 8, 2026

(54) OPERATING LAMP

(71) Applicant: F.A.R.O. FABBRICA APPARECCHIA-TURE RAZIONALI ODONTOIATRICHE S.P.A., Ornago (MB) (IT)

(72) Inventors: Emiliano Bacco, Bellusco (IT); Angelo Favonio, Vimercate (IT)

(21) Appl. No.: 19/482,337

(22) PCT Filed: May 8, 2024
(86) PCT No.: PCT/IB2024/054476

§ 371 Date: Nov. 7, 2025

(30) Foreign Application Priority Data
May 10, 2023 (IT) 102023000009318

(51) Int. Cl. F21V 7/06; F21V 21/28; F21V 21/30; F21W 131/202; F21W 131/205; F21Y 113/13; F21Y 115/10

(52) U.S. Cl. CPC F21V 7/06; F21V 21/28; F21V 21/30; F21W 2131/202; F21W 2131/205; F21Y 2113/13; F21Y 2115/10

(57) ABSTRACT

An operating lamp is provided. The operating lamp comprises a lamp body comprising a central region and an annular region extending around said central region, a first light source, a second light source, a heat sink, a first type reflector, and a second reflector. A first light beam emitted by said first light source being reflected and focused along a first light axis by the first type reflector and. A second light beam emitted by said second light source being reflected and focused along a second light axis by the second reflector. The first and second light sources and are selectively activatable. The first light source, second light source and heat sink are arranged in said central region. The first type reflector and the second type reflector are arranged in said annular region.

### CROSS-REFERENCE TO RELATED APPLICATION DATA

This application is a U.S. National Stage Application of International Application No. PCT/IB2024/054476, filed May 8, 2024, which claims the benefit of and priority to Italian Patent Application No. 102023000009318, filed May 10, 2023, the disclosure of each is incorporated herein by reference in its entirety.

### FIELD

The present invention refers to an operating lamp.

### BACKGROUND

The present invention refers to an operating lamp.

Some technical sectors have the peculiarity of providing that the specialized operator performs their activity focusing their attention and their intervention in a predetermined operating field, the latter being understood as the physical sector or space in which the operator operates.

An example of technical sectors of this nature is dentistry, in which the operating field substantially coincides with the patient's mouth.

Another example of this type of technical sector is surgery, in which the surgeon operates in an operating field (also in this case strongly illuminated) in which the patient lies.

A further example is represented by veterinary medicine, which has lighting needs of a type similar to surgery.

By operating lamp is meant a lamp used to illuminate the operating field with a strongly directional light beam focused on a delimited illumination area.

Direct illumination of the environment surrounding the illumination area by the operating lamp is limited, for example in order to avoid annoying reflections for the operators or, in the case of dental lamps and in some surgical applications, in order to avoid directly illuminating the patient's eyes that are very close to the operating field.

The illumination area, also called “spot” or “bright spot”, has characteristics defined according to the application. For example, there may be a first region of greater luminous intensity and a second surrounding region of lower luminous intensity. The illumination area or the regions that compose it are typically illuminated in a relatively uniform manner.

The boundary between the directly illuminated illumination area and the not directly illuminated surrounding environment is preferably sharp, so as to reduce as much as possible the direct illumination of the surrounding environment.

A typical example of an operating lamp is the dental lamp.

Dental lamps are able to illuminate the patient's oral cavity with a luminous intensity that typically exceeds 25000 lux, can reach and sometimes exceed 70,000 lux, and which is focused in a beam that, from a distance of about 70 centimetres, illuminates the oral cavity of a patient. The requirements of the dental lamps are indicated in the ISO UNI EN 9680 standard.

Some types of dental lamps use two light sources mounted on a lamp body and configured to emit respective light beams and two reflectors integrated into the lamp body in order to reflect the light beams by focusing them along respective light axes.

A reflector of the above-mentioned type comprises a multitude of reflecting surfaces configured to reflect the light coming from the light source so as to obtain the light beam and to focus it on the illumination area with the desired characteristics. Each reflecting surface is positioned and oriented so as to reflect a pre-set amount of light emitted by the light source towards a pre-set point on the illumination area.

Surgical lamps are capable of generating a luminous intensity that typically exceeds 40000 lux and can reach up to 200000 lux from a distance of one metre. Compared to the dental lamps, surgical lamps have a typically greater field depth and can illuminate a larger area.

Typically, surgical lamps comprise a plurality of light sources distributed on the lamp body and provided with optical groups, for example lenses, configured to focus the light beam and to focus it on the illumination area with the desired characteristics.

Both in the case of dental lamps and in the case of dentistry lamps, the power required to obtain the desired luminous intensity typically requires the use of heat sinks to disperse the heat generated by the light sources.

For easy handling, the operating lamps are mounted on an articulated arm that enables the operator to modify the position and the spatial orientation of the lamp.

### SUMMARY

The Applicant has perceived the need for an operating lamp capable of functioning both as a dental and surgical lamp. Such a lamp could be used, for example, when, as part of dental treatment, there is a need for a minor surgical or maxillofacial operation that can be performed on site.

The Applicant has realised that an operating lamp capable of functioning as both a dental lamp and a surgical lamp could be created by using two selectively activatable light groups, one capable of generating a light with characteristics suitable for the dental field and the other capable of generating a light with characteristics suitable for the surgical field.

However, the Applicant has perceived that a lamp of this type would have a significantly greater number of components than a conventional exclusively surgical lamp or exclusively dental lamp, and the resulting weight, size and shape would risk compromising its handling.

The Applicant has noted that the heat sinks and the light sources with the electrical and electronic parts connected to them contribute significantly to the weight of the operating lamp. The Applicant has also noted that the reflectors are relatively light components.

The Applicant has sensed that, if a single heat sink were used for both light groups, the weight of the operating lamp would be reduced.

The Applicant also realised that, if the heat sinks and the light sources were arranged in a central region of the lamp body, a significant part of the weight of the operating lamp could be concentrated in the central region, consequently reducing the moment of inertia of the lamp and improving its handling. Similarly, by arranging reflectors configured to focus the light beams with the desired illumination characteristics in an annular band around the central region, the moment of inertia of the operating lamp would not be significantly increased due to the relatively low weight of the reflectors.

The present invention therefore concerns an operating lamp, comprising:
a lamp body comprising a central region and an annular region extending around said central region;
at least one first light source configured to emit a first light beam towards said annular region;
at least one second light source configured to emit a second light beam towards said annular region;
a heat sink configured to dissipate heat generated by said at least one first light source and at least one second light source;
at least one first type reflector configured to reflect the first light beam emitted by said at least one first light source and to focus said first light beam along a first light axis with a field depth extending from a first minimum distance to a first maximum distance from said lamp body, wherein said first minimum distance has a value comprised between 45 and 65 centimetres and said first maximum distance has a value comprised between 75 and 95 centimetres;
at least one second reflector configured to reflect the second light beam emitted by said at least one second light source and to focus said second light beam along a second light axis with a field depth extending from a second minimum distance to a second maximum distance from said lamp body, wherein said second minimum distance has a value comprised between 70 and 100 centimetres and said second maximum distance has a value comprised between 100 and 140 centimetres; wherein:
said at least one first light source and at least one second light source are selectively activatable;
said at least one first light source, at least one second light source and heat sink are arranged in said central region;
said at least one first type reflector and at least one second type reflector are arranged in said annular region.

The operating lamp can thus be provided with a single heat sink for the at least one first light source and the at least one second light source.

The arrangement of the heat sink, the at least one first light source and the at least one second light source in the central region reduces the moment of inertia of the lamp.

The first type and second type reflectors are relatively lighter than the heat sink and light sources assembly, and therefore do not significantly increase the moment of inertia of the lamp despite being arranged in the annular region.

The operating lamp has a lamp axis oriented according to the general direction of illumination. In the present description and in the appended claims, unless otherwise specified, the terms “axial”, “axially”, “radial”, “radially”, “circumferential” and “circumferentially” are referred to the lamp axis. In particular, by the terms “axially” and “axially” are meant references/quantities arranged/measured or extending in a direction substantially parallel to the lamp axis. By the terms “radial” and “radially” are meant references/quantities arranged/measured or extending in a direction perpendicular to the lamp axis and lying in a plane perpendicular to the lamp axis. By the terms “circumferential” and “circumferentially” are meant references/quantities arranged/measured or extending in an angular direction around the lamp axis and lying in a plane perpendicular to the lamp axis.

The terms “radially inner/outer” refer respectively to a position closer to or farther away from the lamp axis.

By the term “reflector” is meant a body provided with a reflecting surface configured to reflect visible light so as to reflect at least 75% of the incident luminous radiation, for example a mirror.

The present invention may comprise at least one of the preferred features described below.

Preferably, said heat sink is made as a single finned body.

Preferably, no heat sink is placed in the annular region.

Preferably, no first light source is placed in the annular region.

Preferably, no second light source is placed in the annular region.

Preferably, no electrical or electronic components are placed in the annular region.

Preferably said at least one first type reflector is configured to focus the first light beam in a first illumination zone defined between the first minimum distance and the first maximum distance with respect to the lamp body.

Preferably, the first illumination zone has a maximum luminous intensity comprised between 60,000 and 80,000 lux, preferably between 65,000 and 75,000 lux, in particular about 70,000 lux.

Preferably, said at least one first type reflector is configured to create a low intensity region in which the luminous intensity is less than 1200 lux at the patient's eyes.

Preferably, said low intensity region is arranged at 60 mm from an iso-luminance curve corresponding to 90% of the maximum luminous intensity.

Preferably, the first minimum distance has a value comprised between 50 and 60 centimetres.

Preferably, the value of the first minimum distance is about 55 centimetres.

Preferably, the first maximum distance has a value comprised between 80 and 90 centimetres.

Preferably, the value of the first maximum distance is about 85 centimetres.

Preferably said at least one second type reflector is configured to focus the second light beam in a second illumination zone defined between the second minimum distance and the second maximum distance with respect to the lamp body.

Preferably, the second illumination zone has a maximum luminous intensity comprised between 85000 and 200000 lux, preferably between 90000 and 150000 lux, in particular about 100000 lux.

Preferably, said second minimum distance has a value comprised between 75 and 90 centimetres, even more preferably between 75 and 85.

Preferably, the value of the second minimum distance is about 80 centimetres.

Preferably, said second maximum distance has a value comprised between 105 and 130 centimetres, preferably between 110 and 120.

Preferably, the value of the second maximum distance is about 115 centimetres.

Preferably, the second illumination zone is illuminated with a greater luminous intensity than the first illumination zone.

Preferably, the second illumination zone has a greater surface extension than the first illumination zone.

Within the scope of the present disclosure and the appended claims, the first illumination zone and the second illumination zone are defined as the area in which the luminous intensity is greater than 3000 lux. Preferably, the second illumination zone has a greater field depth than the first illumination zone.

Preferably, the second illumination zone has a surface extension comprised between 260 and 650 square centimetres, more preferably between 330 and 550 square centimetres, even more preferably between 380 and 490 square centimetres.

Preferably, the second illumination zone is substantially circular in shape.

Preferably, the second illumination zone has a diameter comprised between 17 and 30 centimetres, more preferably between 20 and 27 centimetres, even more preferably between 22 and 25 centimetres.

Preferably, the first illumination zone is substantially oval in shape.

Preferably, the first illumination zone is conformed in accordance with ISO 9680 standard.

Preferably, the first illumination zone has a surface extension comprised between 100 and 250 square centimetres, even more preferably between 150 and 240 square centimetres.

Preferably, said lamp body comprises a casing, said central region and said annular region being defined inside said casing.

Preferably, said central region is defined at a centre of gravity of said lamp body.

Preferably, said central region placed at a geometric centre of said lamp body.

Preferably, there is provided an articulated arm configured to support said lamp body.

Preferably, said articulated arm comprising an end joint and said lamp body is connected to said end joint at said centre of gravity.

Preferably, there is provided a plurality of first light sources.

Preferably, there are provided two first light sources.

Preferably, each first light source is configured to emit a respective first light beam towards said annular region.

Preferably, there is provided a plurality of first type reflectors.

Preferably, there is provided a first type reflector for each light source.

Preferably, there are provided two first type reflectors.

Preferably, each first type reflector is configured to reflect the respective first light beam emitted by a respective first light source and to focus said respective first light beam along a respective first light axis with a field depth extending from said first minimum distance to said first maximum distance from said lamp body.

Preferably, each first light source is arranged in said central region and wherein each first type reflector is arranged in said annular region.

Preferably, there is provided a plurality of second light sources.

Preferably, there are provided at least three second light sources.

Preferably, there are provided six second light sources.

Preferably, each second light source is configured to emit a respective second light beam towards said annular region.

Preferably, all the first and second light sources are placed in said central region.

Preferably, all the first light sources and the second light sources are mounted on said heat sink.

Preferably, the heat sink is sized to dissipate the heat generated by the second light sources only.

Preferably the first light sources and the second light sources are selectively activatable alternately with each other.

Preferably, there are provided a plurality of second type reflectors.

Preferably, there is provided a second type reflector for each second light source.

Preferably, there are provided at least three second type reflectors.

Preferably, there are provided six pluralities of second type reflectors.

Preferably, each second type reflector is configured to reflect the respective second light beam emitted by a respective second light source and to focus said respective second light beam along a respective second light axis with a field depth extending from said second minimum distance to said second maximum distance from said lamp body.

Preferably, each second light source is arranged in said central region and wherein each second type reflector is arranged in said annular region.

Preferably, all the first type and second type reflectors are placed in said annular region.

Preferably, all the first type and second type reflectors are distributed along the same circumferential distribution centred on a lamp axis passing through said central region.

Preferably, each first type and second type reflector has a respective radial extension measured radially with respect to said lamp axis.

Preferably, the annular region is delimited by an inner circumference and an outer circumference both centred on said lamp axis.

Preferably, said inner circumference has a radius greater than half the average of the radial extensions of all first type and second type reflectors.

Preferably, said outer circumference has a radius less than three times the average of the radial extensions of all first type and second type reflectors.

Preferably, said outer circumference has a radius less than twice the average of the radial extensions of all first type and second type reflectors.

Preferably, all the first type and second type reflectors are entirely contained in said annular region.

Preferably, said central region is delimited by said inner circumference. Preferably, all the first light sources are entirely contained in the central region.

Preferably, all of the second light sources are entirely contained in the central region.

Preferably, the heat sink is entirely contained in the central region.

Further characteristics and advantages of the present invention will become clearer from the following detailed description of preferred embodiment thereof, with reference to the appended drawings and provided by way of indicative and non-limiting example, wherein:

### BRIEF DESCRIPTION OF THE DRAWINGS

FIG. 1A shows a perspective view of an operating lamp in accordance with the present invention;

FIG. 1B shows a perspective view from a different angle of the operating lamp of FIG. 1A;

FIG. 2 shows a sectional view of the operating lamp of FIG. 1A;

FIG. 3 shows a different sectional view of the operating lamp of FIG. 1A;

FIG. 4 shows a partially exploded view of some components of the operating lamp of FIG. 1A;

FIG. 5 shows a top view of some components of the operating lamp of FIG. 1A;

FIGS. 6 and 7 show respective perspective views of components of the operating lamp of FIG. 1A;

FIG. 8 shows a schematic sectional view of the lamp of FIG. 1A in a first operating configuration;

FIG. 9 shows a schematic sectional view of the lamp of FIG. 1A in a second operating configuration;

### DETAILED DESCRIPTION

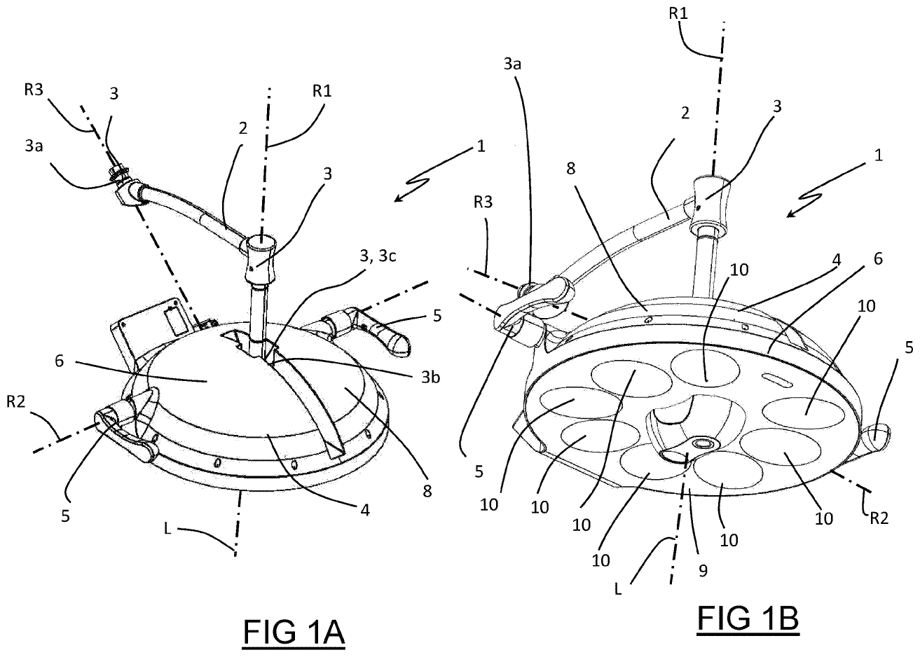

An operating lamp in accordance with the present invention is illustrated in FIGS. 1A and 1B, wherein it is indicated as a whole with reference numeral 1.

The lamp 1 comprises an articulated arm 2 provided with a plurality of joints 3. The articulated arm 2 extends from a first end 3a to a second end 3b. At the first end 3a the articulated arm 2 can be fixed to a support, for example an articulated structure of a dental unit. At the second end 3b, the articulated arm 2 comprises an end joint 3c.

A lamp body 4 is connected to the articulated arm 2 at the end joint 3c. The lamp body 4 is mounted on the articulated arm 2 at its centre of gravity. The centre of gravity of the lamp body 4 refers to the resulting centre of gravity of the lamp body 4 and all the components mounted on it or inside it, illustrated below.

Preferably, the centre of gravity of the lamp body 4 is placed at a geometric centre of the lamp body 4.

The lamp body 4 has a lamp axis L. The lamp 1 is configured to illuminate along the lamp axis L. The centre of gravity of the lamp body 4 is preferably placed along the lamp axis L.

The joints 3 of the articulated arm 2 are configured to allow the lamp body 4 to be rotated in order to direct the lamp axis L. In particular, the joints 3 are configured to allow the lamp body 4 to be rotated around a first rotation axis R1. The first rotation axis R1 is parallel and preferably substantially aligned with the lamp axis L. The first rotation axis R1 passes at the centre of gravity of the lamp body 4.

The joints 3 are also configured to allow the lamp body 4 to be rotated around a second rotation axis R2. The second rotation axis R2 is perpendicular to the first rotation axis R1 and preferably perpendicular to the lamp axis L. The second rotation axis R2 passes at the centre of gravity of the lamp body 4.

The joints 3 are also configured to allow the lamp body 4 to be rotated around a third rotation axis R3. The third rotation axis R3 is perpendicular to the second rotation axis R2 and preferably oblique with respect to the first rotation axis and the lamp axis L. The third rotation axis R3 passes at the centre of gravity of the lamp body 4.

The lamp body 4 comprises two handles 5 that can be gripped by an operator to move the lamp body 4 by acting on the joints 3 of the arm 2. In particular, the handles 5 allow the lamp body 4 to be rotated around the first rotation axis R1, the second rotation axis R2 and the third rotation axis R3.

The lamp body 4 comprises a casing 6 inside which there is defined a containment volume 7 extending around the lamp axis L.

The casing 6 comprises a cap 8 having a concavity defining the containment volume 7. The cap 8 is substantially symmetrical around the lamp axis L.

The casing 6 further comprises a disc 9 fixed to the cap 8 and delimiting together with the cap 8 the containment volume 7. The disc 9 is preferably centred on the lamp axis L.

On the casing 6, and in particular on the disc 9, a plurality of illumination windows 10 are defined, preferably of substantially circular or oval shape, configured to let respective light beams F1, F2 exit from the containment volume 7. The illumination windows comprise respective sheets of transparent material. The illumination windows 10 are distributed circumferentially on the disc 9 around the lamp axis L. In the illustrated embodiment, the illumination windows 10 are eight in number.

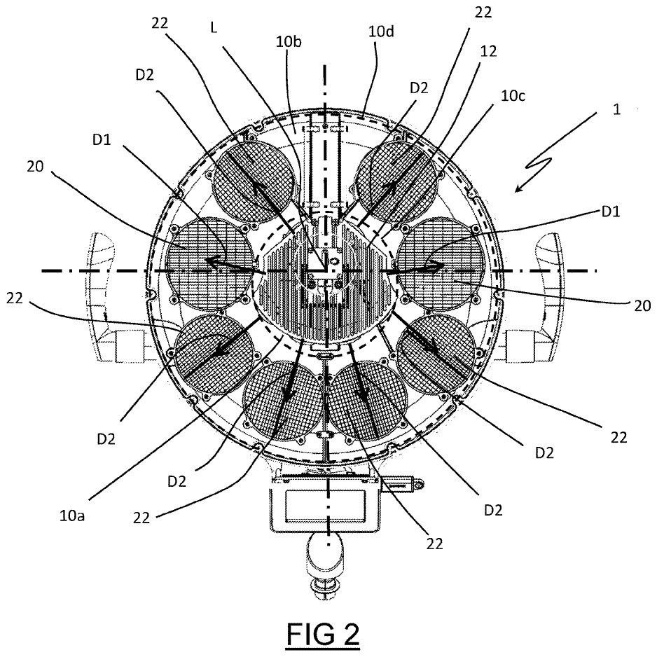

As illustrated in FIG. 2, the lamp body 4 comprises a central region 10a defined in the containment volume 7. The central region 10a is defined along the lamp axis L, at a geometric centre of the containment volume 7. The centre of gravity of the lamp body 4 falls substantially in the centre of the central region 10a.

The lamp body 4 further comprises an annular region 10b defined in the containment volume 7. The annular region 10b is defined circumferentially around the lamp axis L, radially external and adjacent to the central region 10a.

The annular region 10b is delimited internally by an inner circumference 10c, which divides the central region 10a from the annular region 10b, and externally by an outer circumference 10d.

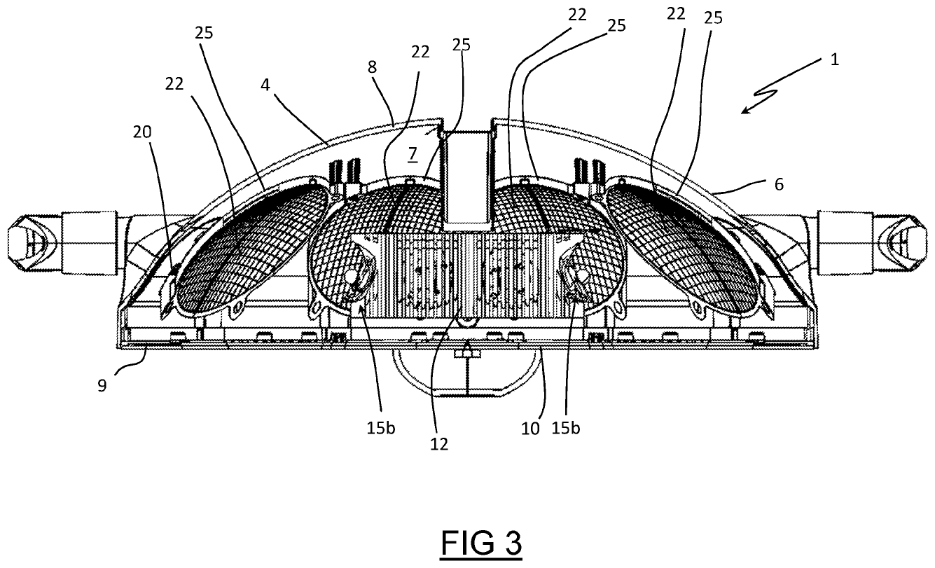

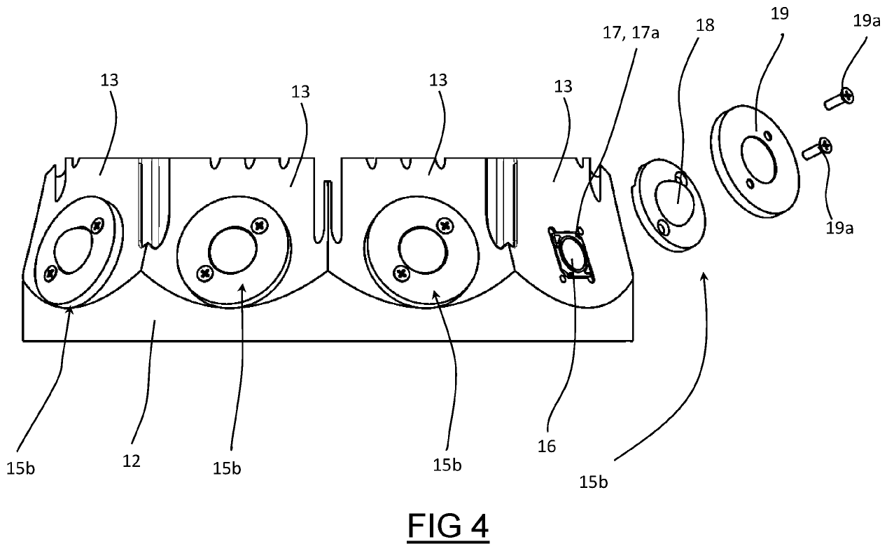

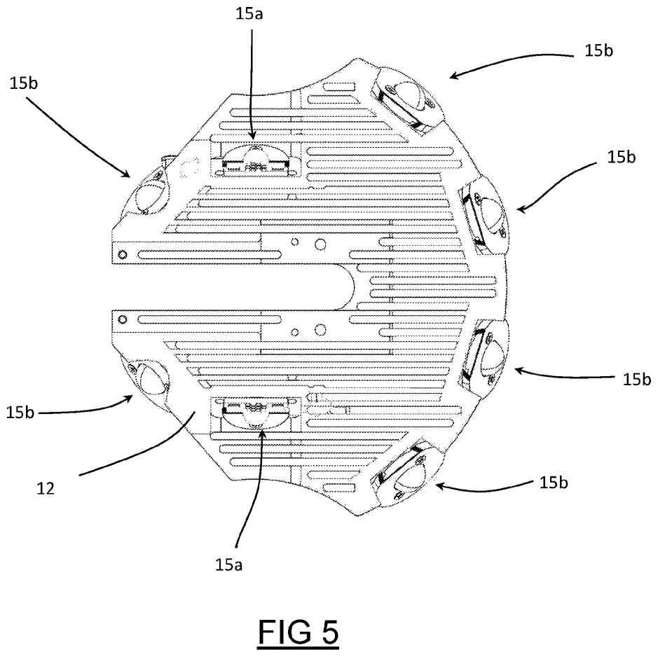

The lamp body 4 comprises a heat sink 12 placed in the containment volume 7, illustrated in FIGS. 3-5. The heat sink 12 is placed in the central region 10a. Preferably, the heat sink 12 is entirely contained in the central region 10a. The heat sink 12 is a finned body made as a single metal piece.

The heat sink 12 comprises a plurality of recessed seats 13, shown in FIG. 4. In particular, the heat sink 12 comprises eight recessed seats 13. The recessed seats 13 are distributed circumferentially around the lamp axis L. The recessed seats 13 are turned towards the annular region 10b.

At least one first light source 15a is mounted on the lamp body 4. In the illustrated embodiment there are two first light sources 15a. The first light sources 15a are configured for dental use.

In the preferred embodiment, the first light sources 15a are configured to emit light at an adjustable temperature. In particular, the first light sources 15a allow to set at least two alternative light temperature values, preferably at least three. In the illustrated embodiment, the first light sources 15a allow to set four alternative light temperature values.

Each first light source 15a is mounted on the heat sink 12 in a respective recessed seat 13. Each first light source 15a is turned towards the annular region 10b and configured to emit a first light beam F1 towards it, in a first direction D1 as illustrated in FIG. 2. The first directions D1 of the first light beams F1 are substantially radial with respect to the lamp axis L and divergent from each other, in particular substantially opposite each other, from the central region 10a to the annular region 10b.

Each first light source 15a is configured to generate a luminous flux comprised between 450 and 600 lumens.

At least a second light source 15b is mounted on the lamp body 4. In the illustrated embodiment there are six second light sources 15b. The second light sources 15b are configured for surgical use.

In the preferred embodiment, the second light sources 15b are configured to emit light with different spectral power distribution with respect to the first light sources 15a. In particular, the light of the second light sources 15b has greater radiance at the red spectrum. This allows the red tissues on which the surgical operator works to be better illuminated.

Each second light source 15b is mounted on the heat sink 12 and in particular in a respective recessed seat 13. Each second light source 15b is turned towards the annular region 10b and configured to emit a second light beam F2 towards it, in a second direction D2 as illustrated in FIG. 2. The second directions D2 of the second light beams F2 are substantially radial with respect to the lamp axis L. The second directions D2 of the second light beams F2 are substantially radial with respect to the lamp axis L and divergent from each other from the central region 10a to the annular region 10b.

Each second light source 15b is configured to generate between 900 and 1200 lumens.

Each light source, first and second, 15a, 15b comprises an LED 16 (light emitting diode) and an electronic control module 17. The LEDs 16 of the illustrated embodiment are of the SMD (surface mounted device) type and are mounted on a printed circuit 17a that integrates the control module 17. In embodiments not illustrated, the LEDs 16 and the printed circuit 17a could be part of a COB (Chip on board) device that integrates the control module 17.

A lens 18 is mounted on each light source, first and second, 15a, 15b.

Each lens 18 superimposed on a first light source 15a, is configured to refract the light produced by the first light source 15a so as to create the respective first light beam F1 with predetermined characteristics. The lens 18 is configured to obtain the first light beam F1 of conical shape, with vertex angle comprised between 50° and 80°, preferably between 60° and 70°.

Each lens 18 superimposed on the second light source 15b is configured to refract the light produced by the second light source 15b so as to create the respective second light beam F2 with predetermined characteristics. The lens 18 is configured to obtain the second light beam F2 of conical shape, with vertex angle comprised between 50° and 80°, preferably between 60° and 70°.

The lenses 18 mounted on the first light sources 15a may have different optical characteristics with respect to the lenses mounted on the second light sources 15b. For example, the lenses 18 can be configured to obtain first light beams F1 and second light beams F2 with substantially equal geometric characteristics starting from different first light sources 15a and second light sources 15b.

A mounting collar 19 is placed on each light source 15a, 15b and on the respective lens 18 to mount them on the heat sink 12. Mounting members 19a, e.g. screws, tighten the mounting collar 19 against the heat sink 12, with the respective lens 18 and the respective light source 15a, 15b interposed between the heat sink 12 and the respective mounting collar.

FIG. 4 shows an exploded view of a second light source 15b, of the respective lens 18 and of the respective mounting collar 19 on the heat sink 12. The first light sources 15a are mounted on the heat sink 12 in a similar manner.

The LED 16 and the control modules 17 of each first light source 15a and second light source 15b are mounted on the heat sink 12 and the heat sink 12 is configured to dissipate heat operatively generated therefrom. The heat generated by the second light sources 15b is overall greater than the heat generated by the first light sources 15a. The heat sink 12 is sized to dispose of the overall heat generated by the second light sources 15b. When the first light sources 15a are active, the heat sink 12 is able to dispose of the heat thereof since it is lower than the design value of the heat sink 12.

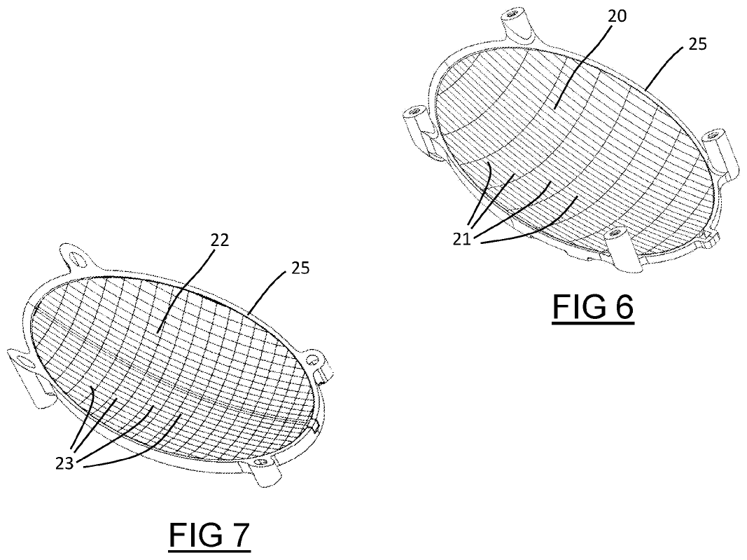

For each first light source 15a, the lamp 1 comprises a first type reflector 20, illustrated in FIG. 6. In the illustrated embodiment, the lamp 1 comprises two first type reflectors 20. The first type reflectors 20 are arranged in the annular region 10b and are preferably entirely contained in the annular region 10b.

Each first type reflector 20 has a concave shape that substantially follows a paraboloid delimited by a substantially circular or oval perimeter. Each first type reflector 20 comprises a plurality of planar reflecting surfaces 21 arranged on the surface of the paraboloid. Each reflecting surface 21 has a substantially rectangular shape. Each reflecting surface 21 is arranged so as to reflect an amount of light emitted by the respective first light source 15a in a predetermined manner.

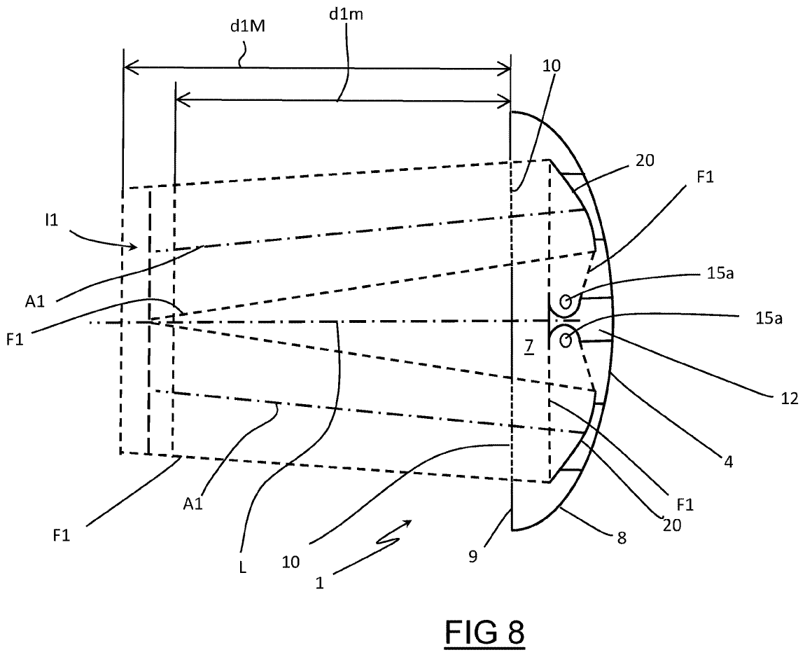

As schematically illustrated in FIG. 8, each first type reflector 20 is configured to reflect a respective first light beam F1 coming from the respective first light source 15a along a respective first light axis A1 extending in the direction of the lamp axis L, preferably substantially parallel to the lamp axis L or, alternatively, slightly convergent or divergent with respect to the lamp axis L. The first light beams F1 reflected by the two first type reflectors 20 are specular with respect to the lamp axis L.

Each first type reflector 20 is configured to reflect the respective first light beam F1 so as to focus it along the respective first light axis A1 with a field depth extending from a first minimum distance d1m from the lamp body 4 equal to 55 centimetres and a first maximum distance d1M from the lamp body 4 equal to 85 centimetres.

The first light beam F1 defines a first illumination zone 11 with predetermined characteristics formed between the first minimum distance d1m and the first maximum distance d1M.

When the first light beam F1 is directed towards a surface placed at a distance from the lamp body 4 comprised between the first minimum distance d1m and the first maximum distance d1M, the light on the surface is focused and forms the first illumination zone I1 on it. When the first light beam A1 is directed towards a surface placed at a distance from the lamp body 4 not comprised between the first minimum distance dim and the first maximum distance d1M, the light on the surface is not focused and does not form the first illumination zone I1 with predetermined characteristics.

The first illumination zone I1 is configured to illuminate the oral cavity of a patient during dental type operations. The maximum luminous intensity in the first illumination zone is comprised between 60,000 and 80,000 lux, preferably between 65,000 and 75,000 lux, in particular about 70,000 lux.

The first illumination zone I1 is further configured to limit the intensity of light directed towards the patient's eyes to a value less than 1200 lux.

In the preferred embodiment, the first illumination zone, defined as the area wherein the luminous intensity exceeds 3000 lux, has an oval shape and dimensions of 200 mm along a first main axis and 100 mm along a second main axis.

The first light beam F1 is also shaped so as to obtain, at 60 mm from an iso-luminance curve corresponding to 90% of the maximum luminous intensity, a region of low luminous intensity with luminous intensity less than 1200 lux.

The first illumination zone I1 is conformed according to the provisions of ISO 9680 standard.

The characteristics of the first illumination zone 11 are obtained by arranging each reflecting surface 21 of the first type reflectors 20 with a pre-set orientation and position with respect to the respective first light source 15a.

For each second light source 15b, the lamp 1 comprises a second type reflector 22, illustrated in FIG. 7. Preferably, the lamp 1 comprises a plurality of second type reflectors 22. In the illustrated embodiment, the lamp 1 comprises six second type reflectors 22. The second type reflectors 22 are arranged in the annular region 10b and are preferably entirely contained in the annular region 10b.

Each second type reflector 22 has a concave shape that substantially follows a paraboloid delimited by a substantially circular or oval perimeter. Each second type reflector 22 comprises a plurality of planar reflecting surfaces 23 arranged on the paraboloid surface. Each reflecting surface 23 has a substantially rectangular shape. Each reflecting surface 23 is arranged so as to reflect an amount of light emitted by the respective second light source 15b in a predetermined manner.

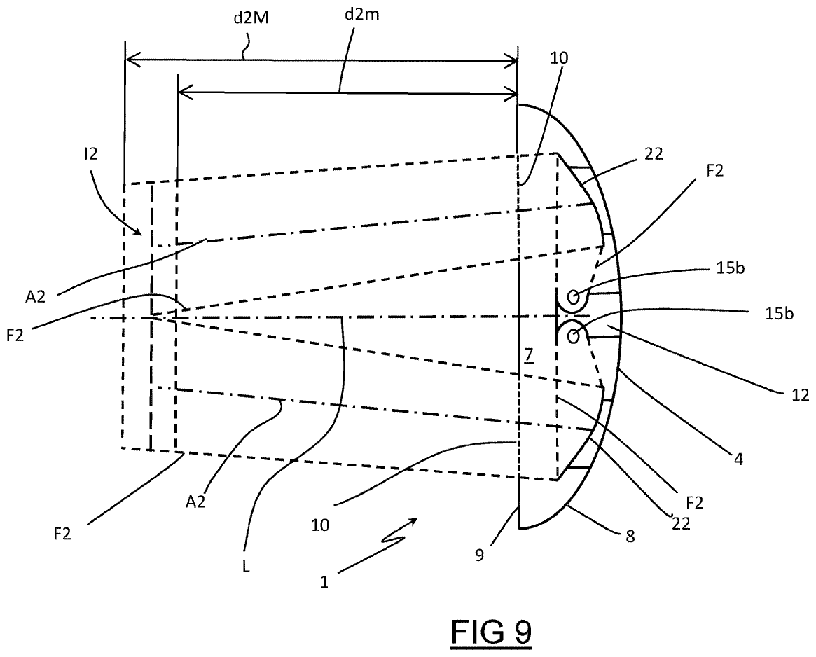

As schematically illustrated in FIG. 9, each second type reflector 22 is configured to reflect a respective second light beam F2 coming from the respective second light source 15b along a respective second light axis A2 extending in the direction of the lamp axis L, preferably substantially parallel to the lamp axis L or, alternatively, slightly convergent or divergent with respect to the lamp axis L. The second light beams F2 reflected by the second type reflectors 22 are specular with respect to the lamp axis L.

Each second type reflector 22 is configured to reflect the respective second light beam F2 so as to focus it along the respective second light axis A2, with a field depth extending from a second minimum distance d2m from the lamp body 4 equal to 80 centimetres and a second maximum distance d2M from the lamp body 4 equal to 115 centimetres.

The second light beam F2 defines a second illumination zone 12 with predetermined characteristics formed between the second minimum distance d2m and the second maximum distance d2M.

When the second light beam F2 is directed towards a surface placed at a distance from the lamp body 4 comprised between the second minimum distance d2m and the second maximum distance d2M, the light on the surface is focused and forms on it the second illumination zone 12. When the second light beam F2 is directed towards a surface placed at a distance from the lamp body 4 not comprised between the second minimum distance d2m and the second maximum distance d2M, the light on the surface is not focused and does not form the second illumination zone 12 with predetermined characteristics.

The second illumination zone 12 is configured to illuminate the body or a portion of the body of a patient during surgical type operations. The field depth of the second illumination zone 12 is greater than the field depth of the first illumination zone 12 to allow greater flexibility in positioning the lamp 1 with respect to the operating field.

The second type reflectors 22 are configured to obtain in the second illumination zone 12 a maximum luminous intensity comprised between 85000 and 200000 lux, preferably between 90000 and 150000 lux, in particular about 100000 lux. The second illumination zone 12 has larger dimensions than the first illumination zone, and in particular comprised between a diameter of 22 and 25 cm.

The characteristics of the second illumination zone 12 are obtained by arranging each reflecting surface 23 of the second type reflectors 22 with a pre-set orientation and position with respect to the respective second light source 15b.

All first type 20 and second type reflectors 22 are distributed along a same circumferential distribution in the annular region 10b. All the first type 20 and second type reflectors 22 are entirely contained in the annular region.

Each first type 20 and second type reflector 22 has a radial extension measured radially with respect to the lamp axis L. The radial extensions of the reflectors 20, 22 can be substantially the same or different from each other.

The inner circumference 10c that delimits the central region 10a externally and the annular region 10b internally has an extension radius greater than half the average of the radial extensions of all the first type 20 and second type reflectors 22. The outer circumference 10b that delimits the annular region 10b externally has an extension radius less than twice the average of the radial extensions of all first type 20 and second type reflectors 22.

Each first type 20 and second type reflector 22 is mounted on the lamp body 4 by means of an adjustable support body 25, which allows to adjust the position and orientation of the reflector 20, 22 with respect to the respective light source 15a, 15b to obtain the desired illumination characteristics.

The first light sources 15a and the second light sources 15b are selectively activatable. By activating the first light sources 15a and by deactivating the second light sources 15b, the first illumination zone I1 described above is obtained by means of the first type reflectors 20. By activating the second light sources 15b and by deactivating the first light sources 15a, the second illumination zone 12 described above is obtained by means of the second type reflectors 22.

The present invention has been described with reference to some preferred embodiments thereof. Various modifications can be made to the embodiments described above, still remaining within the scope of protection of the invention, defined by the following claims.

1. An operating lamp comprising:
a lamp body comprising a central region and an annular region extending around said central region;
at least one first light source configured to emit a first light beam towards said annular region;
at least one second light source configured to emit a second light beam towards said annular region;
a heat sink configured to dissipate heat generated by said at least one first light source and said at least one second light source;
at least one first type reflector configured to reflect the first light beam emitted by said at least one first light source and to focus said first light beam along a first light axis with a field depth extending from a first minimum distance to a first maximum distance from said lamp body, wherein said first minimum distance has a value comprised between 45 and 65 centimetres and said first maximum distance has a value comprised between 75 and 95 centimetres;
at least one second type reflector configured to reflect the second light beam emitted by said at least one second light source and to focus said second light beam along a second light axis with a field depth extending from a second minimum distance to a second maximum distance from said lamp body, wherein said second minimum distance has a value comprised between 70 and 100 centimetres and said second maximum distance has a value comprised between 100 and 140 centimetres; wherein:
said at least one first light source and said at least one second light source are selectively activatable;
said at least one first light source, said at least one second light source and heat sink are arranged in said central region;
said at least one first type reflector and at least one second type reflector are arranged in said annular region.

2. The operating lamp according to claim 1, wherein said lamp body comprises a casing, said central region and said annular region being defined within said casing.

3. The operating lamp according claim 1, wherein said central region is defined at a centre-center of gravity of said lamp body.

4. The operating lamp according to claim 3, comprising an articulated arm configured to support said lamp body, said articulated arm comprising an end joint and said lamp body being connected to said end joint at said center of gravity.

5. The operating lamp according to claim 1, comprising:
two first light sources, each first light source being configured to emit a respective first light beam towards said annular region; and
two first type reflectors, each first type reflector being configured to reflect the respective first light beam emitted by a respective first light source of said two first light sources and to focus said respective first light beam along a respective first light axis with a field depth extending from the first minimum distance to the first maximum distance from said lamp body;
wherein each of the two first light sources is arranged in said central region and wherein each of the two first type reflectors is arranged in said annular region.

6. The operating lamp according to claim 1, comprising:
a plurality of second light sources, each of the plurality of second light sources being configured to emit a respective second light beam towards said annular region; and
a plurality of second type reflectors, each of the plurality of second type reflectors being configured to reflect the respective second light beam emitted by a respective second light source of said plurality of second light sources and to focus said respective second light beam with a field depth extending from a second minimum distance to a second maximum distance from said lamp body;
wherein each of the plurality of second light sources is arranged in said central region and wherein each of the plurality of second type reflectors is arranged in said annular region.

7. The operating lamp according to claim 6, wherein all the plurality of first type and second type reflectors are placed in said annular region, and wherein all the plurality of first and second light sources are placed in said central region.

8. The operating lamp according to any one of claim 7, wherein all the plurality of first type and second type reflectors are distributed along a same circumferential distribution centred on a lamp axis passing through said central region.

9. The operating lamp according to claim 8, wherein:
each of the plurality of first type and second type reflectors has a respective radial extension measured radially with respect to said lamp axis;
said annular region is delimited by an inner circumference and an outer circumference both centred on said lamp axis;
said inner circumference has a radius greater than half of an average of the radial extensions of all the plurality of first type and second type reflectors;
said outer circumference has a radius less than three times of the average of the radial extensions of all the plurality of first type and second type reflectors;
all the plurality of first type and second type reflectors are entirely contained within said annular region.

10. The operating lamp according to claim 9, wherein:
said first minimum distance has a value comprised between 50 and 60 centimetres;
said first maximum distance has a value comprised between 80 and 90 centimetres;
said second minimum distance has a value comprised between 75 and 90 centimetres, preferably between 75 and 85;
said second maximum distance has a value comprised between 105 and 130 centimetres, preferably between 110 and 120.
